(19) United States
(12) Patent Application Publication
(10) Pub. No.: US 2023/0043412 A1
(43) Pub. Date: Feb. 9, 2023

(54) IMAGE FORMING APPARATUS

(71) Applicant: TOSHIBA TEC KABUSHIKI KAISHA, Tokyo (JP)

(72) Inventor: Keita Umeda, Sunto Shizuoka (JP)

(21) Appl. No.: 17/393,505

(22) Filed: Aug. 4, 2021

(51) Int. Cl. H04N 1/00; H04W 4/80

(52) U.S. Cl. CPC H04N 1/00037; H04N 1/00342; H04N 1/00559; H04W 4/80; H04N 2201/0094

(57) ABSTRACT

According to one embodiment, an image forming apparatus includes a detachable device, an antenna, and a control unit. The detachable device is attachable to and detachable from the own apparatus and includes a wireless tag. The antenna receives a wireless signal from the wireless tag if the detachable device is mounted. The control unit determines that the detachable device is mounted to the own apparatus based on the wireless signal received by the antenna.

### FIELD

Embodiments described herein relate generally to an image forming apparatus, a paper feed cassette system, and methods related thereto.

### BACKGROUND

If the paper feed cassette is connected to an image forming apparatus, the paper feed cassette is mounted to the image forming apparatus using a dedicated sheet metal or the like. In the related art, the image forming apparatus is provided with a contact portion that comes into contact with the paper feed cassette if the paper feed cassette is correctly mounted. It is determined whether the paper feed cassette is correctly mounted to the image forming apparatus in response to the state of such a contact portion. However, due to deterioration with time or the like, even if the paper feed cassette is correctly mounted, the image forming apparatus may not be able to recognize the mounting of the paper feed cassette. In such a case, it is likely that the image forming apparatus cannot feed paper from the paper feed cassette. Such a problem is a problem common to all the devices mounted on the image forming apparatus.

### DESCRIPTION OF THE DRAWINGS

FIG. 1 is an external view illustrating an example of the entire configuration of an image forming apparatus according to the embodiment;

FIG. 2 is a block diagram illustrating hardware of the image forming apparatus;

FIG. 3 is a diagram illustrating a specific example of a sheet containing unit;

FIG. 4 is a diagram illustrating a specific example of a position where a wireless tag is provided and a position where a tag reader is provided;

FIG. 5 is a diagram illustrating a specific example of a position where a wireless tag is provided, and a position where a tag reader is provided;

FIG. 6 is a diagram illustrating a specific example of an attribute table;

FIG. 7 is a flowchart illustrating a specific example of a process of a control unit; and

FIG. 8 is a block diagram illustrating hardware of an image forming apparatus according to a modification of the embodiment.

### DETAILED DESCRIPTION

In general, according to one embodiment, an image forming apparatus includes a detachable device, an antenna, and a control unit. The detachable device is a device that is attachable to and detachable from the own apparatus, and includes a wireless tag. An antenna receives a wireless signal from the wireless tag if the detachable device is mounted. The control unit determines that the detachable device is mounted to the own apparatus based on the wireless signal received by the antenna.

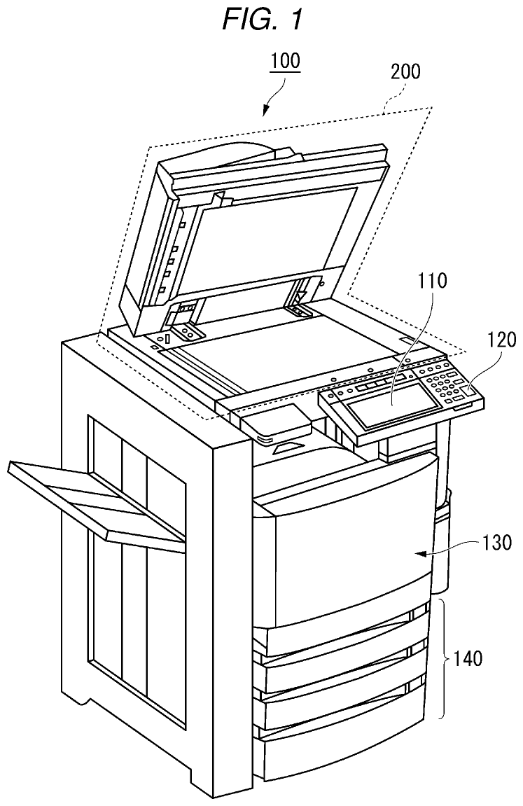

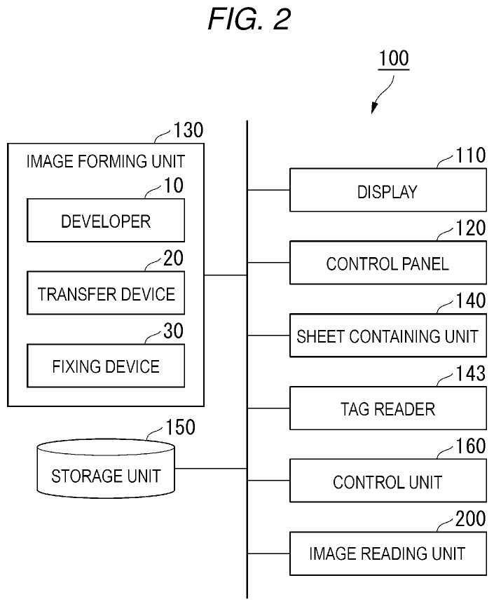

Hereinafter, the image forming apparatus of the embodiment is described with reference to the drawings. FIG. 1 is an external view illustrating an example of the entire configuration of an image forming apparatus 100 according to the embodiment. FIG. 2 is a block diagram illustrating hardware of the image forming apparatus 100 according to the embodiment. The image forming apparatus 100 is, for example, a multifunction device. The image forming apparatus 100 includes a display 110, a control panel 120, an image forming unit 130, a sheet containing unit 140, a tag reader 143, a storage unit 150, a control unit 160, and an image reading unit 200.

The image forming apparatus 100 forms an image on a sheet using a developer such as a toner. The developer is fixed to the sheet by heating. The sheet is, for example, paper or label paper. The sheet may be any material as long as the image forming apparatus 100 can form an image on the surface thereof.

The display 110 is an image display device such as a liquid crystal display or an organic Electro Luminescence (EL) display. The display 110 displays various kinds of information relating to the image forming apparatus 100.

The image forming unit 130 forms an image on the sheet based on image information generated by the image reading unit 200 and image information received via a communication path. The image forming unit 130 includes, for example, a developing device 10, a transfer device 20, and a fixing device 30. The image forming unit 130 forms an image, for example, by the following process. The developing device 10 of the image forming unit 130 forms an electrostatic latent image on a photoconductor drum based on the image information. The developing device 10 of the image forming unit 130 adheres a developer to the electrostatic latent image to form a visible image. Specific examples of the developer include a toner. Examples of toner include decolorable toner, a non-decolorable toner (general toner), and a decorative toner. The toner is stored, for example, in a toner container such as a toner cartridge and supplied to the developing device 10.

The transfer device 20 of the image forming unit 130 transfers the visible image onto the sheet. The fixing device 30 of the image forming unit 130 fixes a visible image to the sheet by heating and pressurizing the sheet. The sheet on which the image is formed may be a sheet contained in the sheet containing unit 140 or may be a sheet that is manually fed.

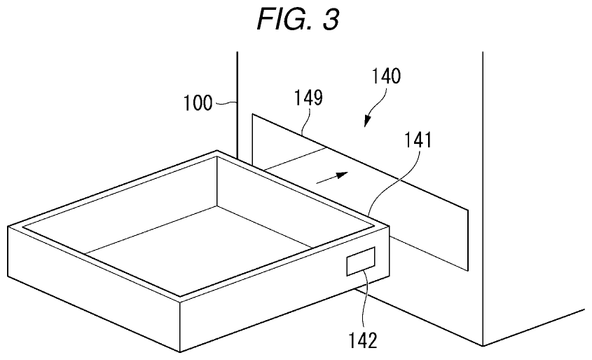

The sheet containing unit 140 contains a sheet used for forming an image in the image forming unit 130. FIG. 3 is a diagram illustrating a specific example of the sheet containing unit 140. The sheet containing unit 140 includes a paper feed cassette 141 and a cassette mounting unit 149.

The paper feed cassette 141 is a device (detachable device) that is attachable to and detachable from the image forming apparatus 100. The paper feed cassette 141 includes a space for containing a sheet inside. The paper feed cassette 141 includes a wireless tag 142. The wireless tag 142 is a wireless tag using a Radio Frequency IDentifier (RFID) technique, and also referred to as an RF tag. The wireless tag 142 stores a specified value (hereinafter, referred to as a “specific value”) in advance. The specific value may be, for example, a value given at the time of manufacturing the wireless tag 142. The specific value is stored in, for example, a storage device (for example, a Read Only Memory (ROM)) of the wireless tag 142. The specific value may be recorded in the wireless tag 142 as a non-rewritable value. If the information is read from the tag reader 143, the wireless tag 142 transmits a specific value stored in the storage device. The specific value may be a value stored in the header instead of the payload in such transmission.

The cassette mounting unit 149 contains the paper feed cassette 141. The cassette mounting unit 149 may be provided with a guide that determines a traveling direction of the paper feed cassette 141 if the paper feed cassette 141 is mounted.

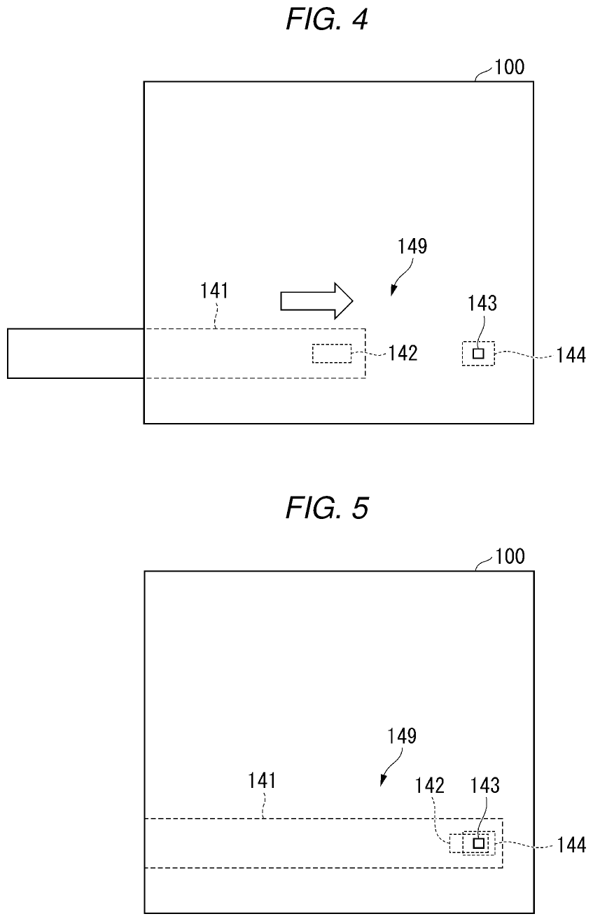

The wireless tag 142 is provided so that a point where the normal line of the mounting surface intersects with the image forming apparatus 100 moves if the paper feed cassette 141 is moved for mounting. In other words, the wireless tag 142 is provided so that the axis of the moving direction if the paper feed cassette 141 is moved for mounting and the normal line of the mounting surface are not parallel but substantially orthogonal to each other. The wireless tag 142 may be provided, for example, on the side surface of the paper feed cassette 141 or on the bottom surface thereof. FIGS. 4 and 5 are diagrams illustrating a specific example of a position where the wireless tag 142 is provided and a position where the tag reader 143 is provided. FIG. 4 is a diagram illustrating a state in which the paper feed cassette 141 is not mounted but is in the middle of being mounted. FIG. 5 is a diagram illustrating a state in which the paper feed cassette 141 is mounted.

The front surface of the image forming apparatus 100 is defined as the surface provided with an insertion port for the paper feed cassette 141. In this case, FIGS. 4 and 5 are diagrams of the image forming apparatus 100 viewed from the right side surface of the image forming apparatus 100. In FIGS. 4 and 5, an insertion port for the paper feed cassette 141 is provided on the left side (front side). If the paper feed cassette 141 is mounted, the paper feed cassette 141 moves from the left side to the right side of FIG. 4.

The tag reader 143 is provided on the cassette mounting unit 149 of the image forming apparatus 100. The tag reader 143 reads information from the wireless tag 142 positioned inside a communication range 144. For example, the tag reader 143 reads a specific value from the wireless tag 142 positioned inside the communication range 144. The communication range 144 of the tag reader 143 may be set as a narrow range. For example, the communication range 144 may be embodied by configuring the tag reader 143, for example, with a narrow directional antenna.

More specifically, as illustrated in FIG. 5, the tag reader 143 is provided so that the wireless tag 142 is positioned inside the communication range 144 if the paper feed cassette 141 is correctly mounted. If the paper feed cassette 141 is not correctly mounted, the tag reader 143 is provided so that the wireless tag 142 is not positioned inside the communication range 144 as much as possible. For example, the directivity of the antenna of the tag reader 143 has directivity in the direction in which the wireless tag 142 is positioned if the paper feed cassette 141 is correctly mounted.

The storage unit 150 is configured with a storage device such as a magnetic hard disk device or a semiconductor storage device. The storage unit 150 stores data required if the image forming apparatus 100 operates. The storage unit 150 may temporarily store data of an image formed by the image forming apparatus 100. The storage unit 150 may store the attribute table.

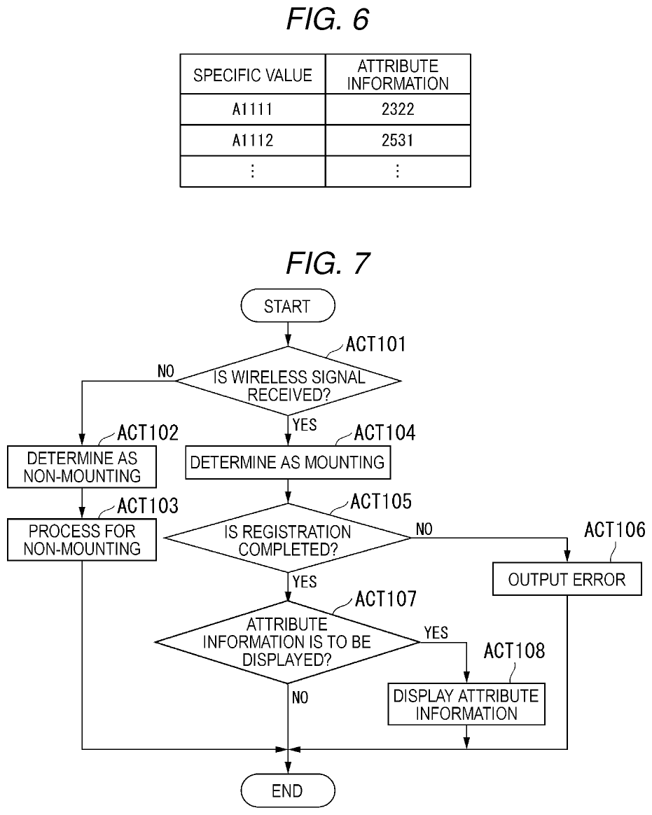

FIG. 6 is a diagram illustrating a specific example of the attribute table. The attribute table includes a plurality of attribute records. Each attribute record has values of a specific value and attribute information. The specific value refers to a specific value stored in the wireless tag 142. The attribute information is information indicating the attributes of the paper feed cassette 141 provided with the wireless tag 142. The attribute information may indicate, for example, the kind of paper feed cassette. The attribute information may indicate, for example, information relating to a lot of paper feed cassettes (for example, a manufacturing location, manufacturing time). In this way, the storage unit 150 stores the specific value and the attribute information of the paper feed cassette 141 including the specific value in an associating manner.

The control unit 160 is configured with a processor such as a Central Processing Unit (CPU) and a memory. The control unit 160 reads and executes a program stored in advance in the storage unit 150. The control unit 160 controls the operation of each device provided in the image forming apparatus 100.

The image reading unit 200 reads image information to be read based on brightness and darkness of light. The image reading unit 200 records the read image information. The recorded image information may be transmitted to another information processing device via a network. The recorded image information may be used for forming an image on the sheet by the image forming unit 130. The image reading unit 200 may include an ADF.

FIG. 7 is a flowchart illustrating a specific example of a process of the control unit 160. If the tag reader 143 does not receive a wireless signal from the wireless tag 142 (ACT 101-NO), the control unit 160 determines that a paper feed cassette is not mounted to the cassette mounting unit 149 (ACT 102). In this case, the control unit 160 executes a process for non-mounting determined in advance (ACT 103). The process for non-mounting may be, for example, a process of stopping a job accompanied by paper feeding or a process of displaying a character string or an image indicating the non-mounting on the display 110.

If the tag reader 143 receives a wireless signal from the wireless tag 142 (ACT 101-YES), the control unit 160 determines that the paper feed cassette 141 is correctly mounted (ACT 104). The control unit 160 refers to the attribute table based on the received specific value. If the received specific value is not registered in the attribute table (ACT 105-NO), the control unit 160 outputs an error. For example, the control unit 160 causes the display 110 to display a character string or an image indicating an error (ACT 106). At this time, the control unit 160 may cause the display 110 to display a character string or an image indicating that the unregistered paper feed cassette 141 is mounted.

If the received specific value is registered in the attribute table (ACT 105-YES), and if an instruction or setting for displaying the attribute information is not made (ACT 107-NO), the control unit 160 waits for an operation by the user without executing any particular process. If the instruction or setting for displaying attribute information is made (ACT 107-YES), the control unit 160 causes the display 110 to display a character string or an image indicating the attribute information registered in the attribute table in association with a specific value (ACT 108).

In the image forming apparatus 100 of the embodiment configured as described above, whether the paper feed cassette 141 is correctly mounted to the image forming apparatus 100 is determined based on wireless communication. Specifically, if the wireless tag 142 provided on the paper feed cassette 141 and the tag reader 143 provided on the cassette mounting unit 149 can communicate with each other, it is determined that the paper feed cassette is correctly mounted. Since the determination is made based on wireless communication, the deterioration over time or the like is hardly received as compared with the case where the mounting is determined based on the physical contact of the device. Therefore, the image forming apparatus 100 can more accurately determine that the paper feed cassette 141 is correctly mounted.

The wireless tag 142 is provided so that the point where the normal line intersects with the image forming apparatus 100 moves if the paper feed cassette 141 is moved for mounting. The tag reader 143 is provided so that the wireless tag 142 is positioned inside the communication range 144 if the paper feed cassette 141 is correctly mounted. The tag reader 143 is configured, for example, by setting directivity to be narrow. With this configuration, the wireless tag 142 can be configured not to be positioned inside the communication range 144 until the paper feed cassette 141 is correctly mounted (for example, while moving). Therefore, the image forming apparatus 100 can more accurately determine that the paper feed cassette 141 is correctly mounted.

### Modification

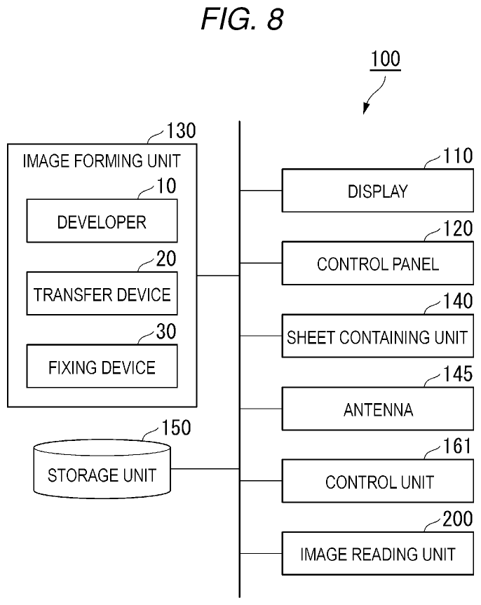

FIG. 8 is a block diagram illustrating hardware of the image forming apparatus 100 according to a modification of the embodiment. The differences from the embodiment illustrated in FIG. 2 are the following two points: a point that an antenna 145 is provided instead of the tag reader 143, and a point that a control unit 161 is included instead of the control unit 160. The tag reader 143 includes an antenna and a processor. The processor of the tag reader 143 generates a signal transmitted to the wireless tag 142 via the antenna and decodes the signal received from the wireless tag 142 via the antenna. On the other hand, the antenna 145 in the modification is provided at the same position as the tag reader 143, and is the same as the antenna of the tag reader 143 in terms of the characteristics such as the directivity. The antenna 145 is connected to the control unit 161. The control unit 161 performs the same processing as the processor of the tag reader 143. That is, the control unit 161 generates a signal transmitted to the wireless tag 142 via the antenna 145, and decodes the signal received from the wireless tag 142 via the antenna 145.

With this configuration, the amount of hardware (particularly the processor) required to communicate with the wireless tag 142 can be reduced.

A device provided with the wireless tag 142 does not have to be limited to the paper feed cassette 141. The wireless tag 142 may be provided in any device mounted to the image forming apparatus 100. For example, the wireless tag 142 may be provided to the post-processing device. For example, the wireless tag 142 may be provided to a toner container such as a toner cartridge. For example, the wireless tag 142 may be provided to the photoconductor drum. For example, the wireless tag 142 may be provided to a large-capacity paper feed cassette. For example, the wireless tag 142 may be provided to a document feeder. In any case, the tag reader 143 or the antenna 145 is provided so that the wireless tag 142 is positioned within the communication range if each device is correctly mounted to the image forming apparatus 100.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein maybe made without departing from the spirit of the inventions. The accompanying claims and their equivalents are intended to cover such forms or modifications as would fall within the scope and spirit of the invention.

What is claimed is:

1. An image forming apparatus, comprising:
a detachable device configured to be attachable to and detachable from the image forming apparatus and include a wireless tag;
an antenna configured to receive a wireless signal from the wireless tag if the detachable device is mounted; and
a controller configured to determine that the detachable device is mounted to the image forming apparatus based on the wireless signal received by the antenna.

2. The image forming apparatus according to claim 1,
wherein the antenna does not receive a wireless signal from the wireless tag until the detachable device is correctly mounted to the image forming apparatus, and receives a wireless signal from the wireless tag if the detachable device is correctly mounted to the image forming apparatus.

3. The image forming apparatus according to claim 2,
wherein the antenna has directivity.

4. The image forming apparatus according to claim 3,
wherein the antenna has directivity in a direction in which the wireless tag is positioned when the detachable device is correctly mounted to the image forming apparatus.

5. The image forming apparatus according to claim 1,
wherein the wireless tag is provided so that a point where a normal line of a mounting surface intersects with the image forming apparatus moves if the detachable device is moved for mounting.

6. The image forming apparatus according to claim 1,
wherein the wireless tag is provided so that an axis of a moving direction if the detachable device is mounted and a normal line of the mounting surface are not parallel to each other.

7. The image forming apparatus according to claim 1,
wherein the wireless signal includes a specific value recorded in the wireless tag when being manufactured.

8. The image forming apparatus according to claim 7,
wherein the specific value is a value that is not able to be rewritten to the wireless tag.

9. The image forming apparatus according to claim 1,
wherein a value of the wireless signal is not stored in a payload.

10. The image forming apparatus according to claim 1,
wherein the detachable device is a paper feed cassette.

11. A paper feed cassette system, comprising:
a detachable device including a wireless tag and configured to be attachable to and detachable from an image forming apparatus;
an antenna configured to receive a wireless signal from the wireless tag if the detachable device is mounted; and
a controller configured to determine that the detachable device is mounted to the image forming apparatus based on the wireless signal received by the antenna.

12. The paper feed cassette system according to claim 11,
wherein the antenna does not receive a wireless signal from the wireless tag until the detachable device is correctly mounted to the image forming apparatus, and receives a wireless signal from the wireless tag if the detachable device is correctly mounted to the image forming apparatus.

13. The paper feed cassette system according to claim 12,
wherein the antenna has directivity.

14. The paper feed cassette system according to claim 13,
wherein the antenna has directivity in a direction in which the wireless tag is positioned when the detachable device is correctly mounted.

15. The paper feed cassette system according to claim 11,
wherein the wireless tag is provided so that a point where a normal line of a mounting surface intersects with the image forming apparatus moves if the detachable device is moved for mounting.

16. The paper feed cassette system according to claim 11,
wherein the wireless tag is provided so that an axis of a moving direction if the detachable device is mounted and a normal line of the mounting surface are not parallel to each other.

17. The paper feed cassette system according to claim 11,
wherein the wireless signal includes a specific value recorded in the wireless tag when being manufactured.

18. The paper feed cassette system according to claim 17,
wherein the specific value is a value that is not able to be rewritten to the wireless tag.

19. A method for an image forming apparatus, comprising:
attaching and detaching from the image forming apparatus a detachable device including a wireless tag;
receiving, by an antenna, a wireless signal from the wireless tag if the detachable device is mounted to the image forming apparatus; and
determining that the detachable device is mounted to the image forming apparatus based on the wireless signal received by the antenna.

20. The method according to claim 19, further comprising:
receiving a wireless signal from the wireless tag upon or after the detachable device is correctly mounted to the image forming apparatus, with the proviso that
a wireless signal is not received from the wireless tag if the detachable device is not correctly mounted to the image forming apparatus.
